(19) United States
(12) Patent Application Publication
(10) Pub. No.: US 2014/0311993 A1
(43) Pub. Date: Oct. 23, 2014

(54) Apparatus and method for separating a liquid from other substances

(71) Applicants: Dino Pezzimenti, North Chili, NY (US); Paul Rowe, Fairport, NY (US); Aaron Rowe, Fairport, NY (US); Raymond Cich, Clarence, NY (US)

(72) Inventors: Dino Pezzimenti, North Chili, NY (US); Paul Rowe, Fairport, NY (US); Aaron Rowe, Fairport, NY (US); Raymond Cich, Clarence, NY (US)

(21) Appl. No.: 13/865,842

(22) Filed: Apr. 18, 2013

(51) Int. Cl. B01D 21/30; B01D 21/00

(52) U.S. Cl. CPC B01D 21/307; B01D 21/0033
USPC 210/800; 210/254

(57) ABSTRACT

An apparatus for separating a liquid from other substances comprises a first chamber, a second chamber, an inlet connected to the first chamber, an outlet connected to the second chamber, a bypass conduit passing from the inlet, through the first chamber, and into the second chamber, and a passage between the first and second chambers and configured to allow the liquid to flow from the first chamber to the second chamber, the passage located below the bypass conduit, wherein the bypass conduit comprises a first orifice located within the first chamber and a second orifice located in the second chamber.

### BACKGROUND OF THE INVENTION

The present invention relates to a precast concrete stormwater treatment system with specialty internal plastic pipe. The present invention relates generally to the treatment of waste streams (e.g., process or storm water runoff, etc.). More particularly the present invention relates to the removal of floatable and non-floatable matter therein so that cleaner liquid is returned to the process (e.g., environment).

Oil and grit separators, also known as hydrodynamic separators, are used to control hydrocarbon, floatable matter, and sediment loadings by removing them from a waste stream and containing them for future removal and disposal. Such a separator comprises a structure made totally of a durable material, usually concrete, or a combination of durable materials. It is accordingly an object of the present invention to provide a more efficient treatment apparatus for removing sediments, floatable debris, and hydrocarbons while limiting re-suspension and re-entrainment of previously captured material. It is also an object of the present invention to provide such an apparatus that is inexpensive, easy to operate (passive), and reliable.

As can be seen, there is a need for solutions to these and other problems.

### SUMMARY OF THE INVENTION

In one aspect of the present invention, an apparatus for separating a liquid from other substances comprises: a first chamber; a second chamber; an inlet connected to the first chamber; an outlet connected to the second chamber; a bypass conduit passing from the inlet, through the first chamber, and into the second chamber; a passage between the first and second chambers and configured to allow the liquid to flow from the first chamber to the second chamber, the passage located below the bypass conduit, wherein the bypass conduit comprises a first orifice located within the first chamber and a second orifice located in the second chamber.

In another aspect, an apparatus for separating a liquid from other substances comprises: a first chamber; a second chamber; an inlet connected to the first chamber; an outlet connected to the second chamber; a bypass conduit passing from the inlet, through the first chamber, and into the second chamber; a passage between the first and second chambers and configured to allow the liquid to flow from the first chamber to the second chamber, the passage located below the bypass conduit, wherein the bypass conduit comprises a first orifice located within the first chamber and a second orifice located in the second chamber, wherein the second orifice comprises a notch in the bypass conduit, the notch having a height relative to a bottom surface of the bypass conduit and a width relative to an end of the bypass conduit, wherein the bypass conduit is angled at an angle relative to a horizontal so that a lowest region of the notch is higher, in relation to the horizontal, than a highest region of the first orifice, such that liquid flow into the inlet, less than a design flow, flows substantially entirely through the first orifice, and wherein the first orifice comprises a slot in the bypass conduit having an area sufficient to allow liquid flow into the inlet, less than the design flow, to substantially entirely flow through the first orifice.

In another aspect, a method of separating a liquid from other substances comprises: providing the apparatus as described; providing a mixture of the liquid and other substances into the inlet; and directing the liquid from the outlet.

In order to provide such an apparatus, in accordance with the present invention, contaminated liquid may be passed into the treatment/holding chamber via an orifice (such as a butterfly opening) in the inlet/bypass conduit wherein non-floatable matter is removed from the contaminated liquid by the action of the effects of gravity (explained with Stokes Law). In addition, some gross hydrocarbons and other floatable matter, also part of the contaminated liquid stream, introduced therein through the same butterfly opening are also removed from the contaminated liquid by the actions of buoyancy (explained with Stokes Law).

Not all of the hydrocarbons and floatable matter exit the liquid stream at these slots. Additional flow of hydrocarbons and floatable matter from the inlet/bypass conduit into the treatment/holding chamber occurs at the transition purge orifice until such time that the orifice becomes hydraulically locked. The majority of the non-floatable and floatable matter is trapped in the treatment/holding chamber. The trapping mechanism is achieved via combination of the inlet pipe slots, the inlet pipe negative slope, the inlet pipe check dam regulator, the orifice, and the baffle wall with openings.

The inlet/bypass conduit extends through the baffle wall from the treatment/holding chamber into the confluence chamber and is provided as a watercourse for liquid in excess of the amount requiring treatment. This liquid and the liquid that passes through the baffle wall openings converge in the confluence chamber prior to exiting the present invention through the outlet conduit of the present invention.

These and other features, aspects and advantages of the present invention will become better understood with reference to the following drawings, description and claims.

### BRIEF DESCRIPTION OF THE DRAWINGS

FIG. 1: is a cutaway perspective view of one embodiment of the invention.

FIG. 2: is a section view of one embodiment of the invention taken along line 2-2 in FIG. 1.

FIG. 3: is a cutaway perspective view of an alternate embodiment of the invention.

FIG. 4: is a section view of the alternate embodiment invention taken along line 4-4 in FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

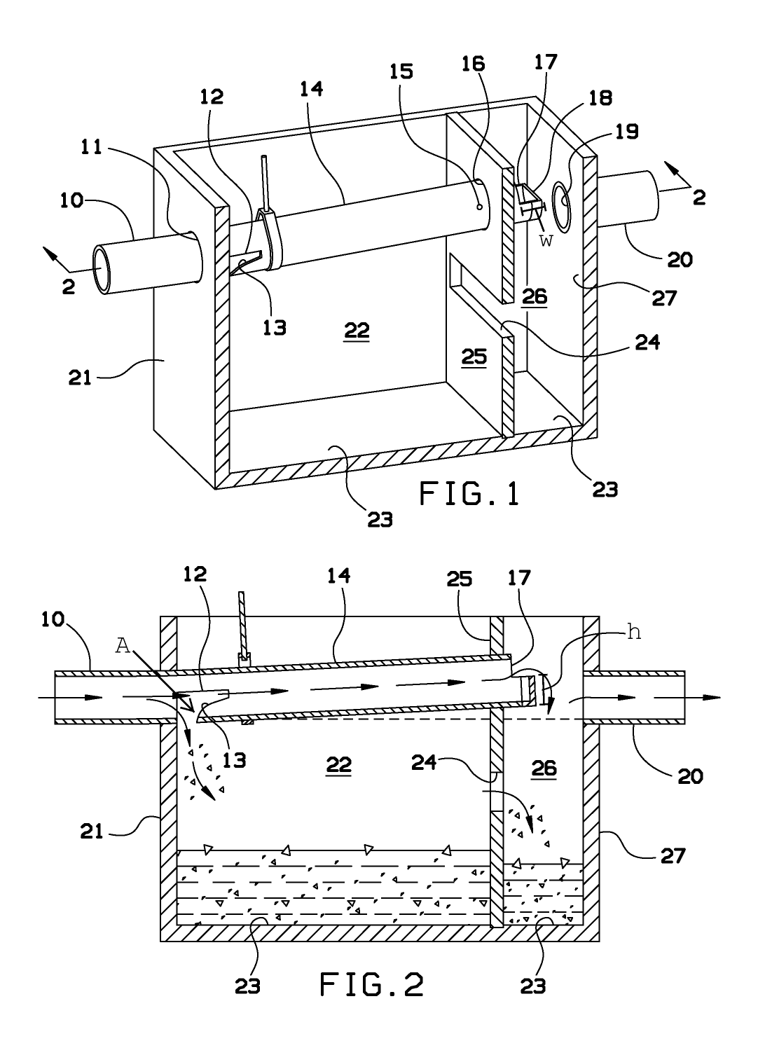

Referring now to the FIGS. 1 and 2, an apparatus for treating liquid such as storm water or other flows from industrial, commercial, and urban applications is disclosed. The liquid is treated by removing non-floatable matter such as sediment (sand, silt, clays) hydrocarbon-laden sediment, debris, nutrients, heavy metals, as well as gross floatable matter such as hydrocarbons, organic matter, and litter. The contaminated liquid is received through the inlet conduit 10 (e.g., pipe) through an opening 11 in the side wall 21 of the structure, and the treated liquid is discharged through the outlet conduit(s) 20 through an opening in the opposite wall 27 for return to the process (environment) or as otherwise desired.

Immediately upon entering the apparatus, the inlet conduit 10 is attached to (and/or becomes) the bypass conduit 14, which may be integrally formed with the inlet conduit 10. The bypass conduit 14 continues through the treatment/holding chamber 22, passes through an opening 16 in the baffle wall 25, and terminates in the confluence chamber 26 with a cap 18 on the end of the conduit. The inlet conduit 10, bypass conduit 14 and the outlet conduit 20, as well as other conduits described in this specification, which may be composed of steel, plastic, or other suitable materials, may be suitably sealed and secured in the openings in their respective walls by grout, or other suitable means (e.g., flexible boots).

The first chamber, the treatment/holding chamber 22, is contained within a structure, that may be square or round and is composed of a wall(s) 21, 27, a floor 23, and a ceiling, suitably joined together and composed of suitable material such as, for example, high strength steel-reinforced corrosion-resistant precast concrete suitable for heavy traffic loading as required. The floor 23 may be a monolithic base section desirably providing anti-floatation of the structure. The structure may, for example, be, but is not limited to, on the order of about 1.8 to 3.7 meters (6 to 12 feet) high and about, but is not limited to, 0.9 to 36.6 meters (3 to 120 feet) in inside dimension depending on the flow rate, on the order of about 2.8 to 10,620 liters per second (0.1 to 375 cubic feet per second) or higher, that the apparatus is capable of handling. The second chamber, called the confluence chamber 26, is generally contained within the same structure but may also be contained within a separate structure that may also be either round or square. The outlet conduit 20 may be sized (e.g., has a diameter) to handle the flow rate and thus would typically be sized equal approximately to the inlet conduit 10.

The bypass conduit 14 has four features with unique and interdependent hydraulic functions along its length. The four features are (a) the butterfly orifice, (b) the check dam regulator, (c) the upward tilt angle of the bypass conduit 14 away from the horizontal, and (d) the transition purge orifice.

(a) The first bypass conduit feature, which may also be known as butterfly orifice 13, is cut or formed into the lower portion of the bypass conduit 14, adjacent to the inlet 11, and is called the butterfly orifice 13. The shape and size of the butterfly orifice 13 are engineered to eject the incoming fluid from the bypass conduit 14 with minimal hydraulic losses and an evenly diffused flow in all forward and sideways directions while also minimizing the downward component of the flow velocity. This is to prevent a liquid stream from entering the treatment/holding chamber with enough force to disturb previously settled particles on the bottom of the chamber, even under high-flow conditions.

(b) The second bypass conduit feature, the check dam regulator 17, is formed by cutting a notch into the capped 18 end of the bypass conduit 14 within the confluence chamber 26. The elevation of the check dam regulator 17 is the component of the feature that determines the hydraulic head used to drive flow through the butterfly orifice 13 and into the treatment/holding chamber 22. The length of the check dam regulator 17 notch is the component of the feature that determines the fraction of the flow that is bypassed under high-flow conditions. Since the shape of the opening at the outlet end of the bypass conduit is what defines the check dam regulator, item 17 in the figures will be interchangeably referred to as both the opening in the outlet end of the bypass pipe and the check dam regulator.

(c) Interdependence is had between the butterfly orifice 13 and the check dam regulator 17 in that the head required to force the desired treatment flow through the butterfly orifice 13 is directly provided by the elevation of the check dam regulator 17. Some design scenarios can require a check dam regulator elevation that is higher than the bypass conduit is tall. The higher the check dam regulator 17 is formed relative to the invert of the conduit, the more restrictive the resulting opening. The third bypass conduit feature, the upward tilt of the bypass conduit 14, may be added to allow the check dam regulator 17 to have any desired elevation relative to the butterfly orifice 13 while also maintaining a relatively low elevation relative the capped end 18 of the bypass conduit 14. This design provides greater hydraulic pressure in the bypass conduit 14 without creating geometry in the check dam regulator 17 that would restrict the flow under high-flow conditions. Through careful hydraulic balancing of these two features 13, 17, during low-flow and transition-flow conditions the unit treats all flow for floatable and non-floatable matter up to a specified “treatment” or design flow, and under high-flow conditions the unit continues to treat that specified “treatment” flow safely for non-floatable matter while allowing all superfluous flow to pass through harmlessly and return to the process (e.g., environment).

Additional interdependence may be had between the butterfly orifice 13 and the check dam regulator 17 that deserves attention. The top 12 of the butterfly orifice 13 may be constrained to be slightly below the level of the check dam regulator 17 so as to permit all incoming floating matter to pass freely through the butterfly orifice 13 under low-flow conditions. Under transition-flow conditions and high-flow conditions, the liquid level in the treatment/holding chamber rises above the butterfly orifice 13, creating a hydraulic lock to trap all floatable matter in the treatment/holding chamber 22. Thus, under high-flow conditions, even the most vigorous bypass flow can pass through the unit without re-entraining any floatable matter from the treatment/holding chamber 22.

(d) The fourth bypass conduit feature, the transition purge orifice 15, is placed on the side of the bypass conduit 14 immediately adjacent to and upstream of the baffle wall 25. During transition-flow conditions, the water level rises above the top cut 12 of the butterfly orifice 13 but has not reached the elevation of the check dam regulator. When the flow rises above the level of the butterfly orifice 13 some floating matter may remain trapped on the inside of the conduit water lock described in the previous paragraph. Under transitional flow conditions this floatable matter remains trapped behind the check dam regulator 17 and is allowed to skim off the top and drain into the treatment/holding chamber through the transition purge orifice 15. Thus, any trapped floatable matter trapped within the bypass conduit can be purged before reaching high-flow conditions when bypass flow passes over top of the check dam regulator 17.

While liquid is entering into the apparatus (e.g., a storm event) during low flows, the liquid flows through the inlet conduit 10 into the bypass conduit. Some of the flow in the bypass conduit 10 makes a circuitous path past the butterfly orifice 13 (because of its incoming momentum) to the check dam regulator 17 and back.

At that time the butterfly orifice and purge orifice 13, 15 are not below the liquid surface elevation and floatable matter flows freely through the butterfly orifice 13 and/or transition purge orifice 15 and into the treatment/holding chamber 22, spreading uniformly across the width of the chamber 22 to achieve a long path length for the flow stream through the treatment/holding chamber 22. This allows the maximum amount of non-floatable matter to desirably be deposited out or dropped to the bottom of the treatment/holding chamber 22 and the floatable matter to rise and thereby become separated and trapped in the same chamber.

When the flow rate increases sufficiently such that the liquid surface elevation rises above the top of the butterfly orifice 12 and the transition purge orifice 15, the flow of floatable matter out of the orifices 13, 15 and into the treatment/holding chamber 22 ceases. The floatable matter in the treatment/holding chamber 22 is then trapped in the treatment/holding chamber 22. The liquid, less the non-floatable matter 12 and floatable matter trapped in the treatment/holding chamber 22, flows from the treatment/holding chamber 22 through the opening(s) 24 of the baffle wall 25 into the confluence chamber 26. Additional settling of non-floatable matter (e.g., fine material such as clay) may occur in the confluence chamber 26 if there is non-floatable matter remaining in the liquid. The liquid transferred through the baffle opening(s) 24 converges with any excess liquid transferred from the butterfly orifice 13. This liquid exits the apparatus through the outlet conduit 20.

The inlet conduit 10 is disposed, as illustrated in all figures to enter the treatment/holding chamber 22 horizontally centered to the treatment/holding chamber 22 and extending in through the treatment/holding chamber 22 and through the baffle wall 25 into the confluence chamber 26. The bypass conduit 14 may be sloped anywhere from 0° to 10° whereby the outlet end 18, of the bypass conduit 14 is at an equal or higher elevation than the inlet conduit 10. The liquid is thus introduced into the treatment/holding chamber 22 from the bypass conduit 14 through the butterfly orifice 13. The butterfly orifice 13 is specifically engineered for size and location to divert the liquid on a path that enhances removal of the non-floatable matter and the floatable matter, without causing re-suspension of the non-floatable matter or re-entrainment of the floatable matter.

Part of the liquid remains in the bypass conduit 14 during an event. This flow of this part of the liquid is stopped at the outlet end 18 of the bypass conduit 14 by the check dam regulator 17. The check dam regulator 17, in concert with the butterfly orifice 13 and the baffle openings 24, regulates the liquid into the treatment/holding chamber 22 to a specified flow rate. Any excess liquid over the specified flow rate exits the bypass conduit 14 at the outlet end 18 through an opening in the top of the bypass conduit 14 formed by the check dam regulator 17. The check dam regulator 17 is specifically engineered for size and location.

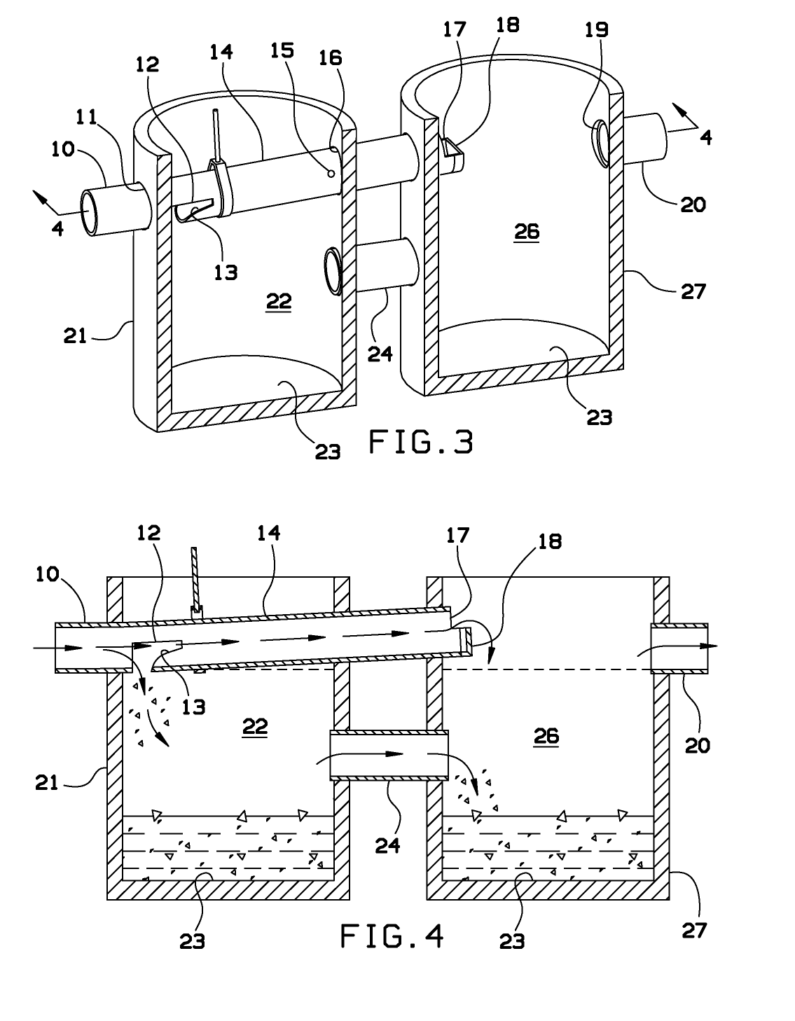

Referring now to FIGS. 3 and 4, there is shown generally an apparatus in accordance with an alternative embodiment of the present invention. This alternative apparatus uses two separate chambers and/or structures (housings) as opposed to using one structure as described in the embodiment shown in FIGS. 1 and 2. Similar to the single structure apparatus, the alternative embodiment includes the afore-mentioned components of the primary embodiment with the difference of the alternative embodiment including conduits 24 for passage of the treated liquid from the primary chamber 22 to the secondary chamber 26.

Other embodiments of the present invention may be described as follows. The present invention may include an apparatus for separating floating and non-floating particulates from liquid wherein the apparatus includes a treatment/holding chamber for collecting non-floating and floating particulates and a confluence chamber where treated and overflow liquid combine and are discharged from the apparatus. A side-stream flow may be diverted to an ancillary chamber for additional treatment including, but not limited to high efficiency oil/water separation, nutrient removal, heavy metal removal, etc. An inlet/bypass conduit for introducing liquid into the apparatus is provided with an upward slope (i.e., the downstream end of said conduit is at a higher elevation than the upstream end of the same conduit) and passes through the treatment/holding chamber and a baffle wall into the confluence chamber. An opening, which may be called the butterfly orifice in reference to its shape as viewed from a plan view, is cut or formed in the inlet/bypass conduit adjacent to its entry point into the structure, usually prior to installation of the inlet/bypass conduit into the structure, to provide a laterally dispersed, low velocity flow of liquid from the inlet conduit, into the treatment/holding chamber with as much of a forward and sideways direction as possible. These butterfly orifices are specifically engineering sized and located using proprietary calculations that account for flow dynamics, liquid temperature, particle size, structure surface area, and other characteristics of the project/site/etc.

One or more additional orifices, called “transition purge orifices”, may be cut or formed in the inlet/bypass conduit, usually prior to installation of the inlet/bypass conduit into the structure, downstream of the butterfly orifice to provide an outlet for trapped hydrocarbons from the inlet conduit into the treatment/holding chamber. These orifices are specifically engineering sized and located using proprietary calculations that account for flow dynamics, liquid temperature, particle size, structure surface area, and other characteristics of the project/site/etc. The location and size of the butterfly orifice is such that at or above a specified flow rate, the butterfly orifice is below the surface elevation of the liquid in the apparatus thus providing hydraulic locking. During times of no-flow to the apparatus, these butterfly orifices are above the surface elevation of the liquid in the apparatus.

The end of the inlet conduit, which is in the confluence chamber, is also formed, usually prior to installation of the inlet pipe into the apparatus, to allow an opening for an avenue of excess liquid flow through the apparatus. The location of this opening usually will be at the top portion of the inlet pipe end. This opening forms a check dam regulator at the outlet end of the inlet pipe. The check dam regulator is specifically engineering sized and located using proprietary calculations that account for flow dynamics, liquid temperature, particle size, structure surface area, and other characteristics of the project/site/etc. Between the treatment/holding and confluence chambers is a baffle wall with openings formed usually prior to installation of the baffle wall into the structure. These openings are specifically engineering sized and located using proprietary calculations that account for flow dynamics, liquid temperature, particle size, structure surface area, and other characteristics of the project/site/etc. and allow the primary avenue of flow through the apparatus. A purpose of the baffle wall is to serve as a hydraulic lock to trap and retain floating particulates (e.g., hydrocarbons, etc.). The check dam regulator, the upward slope of the inlet/bypass conduit, the butterfly orifice, and the baffle wall openings regulate the flow through the apparatus. Any ancillary treatment will be either a side stream prior to or after the apparatus or full flow prior to or after the apparatus if an ancillary treatment is used.

Other embodiments of the present invention may be described as follows. An apparatus for separating a liquid from other substances comprises: a first chamber, such as treatment/holding chamber 22; a second chamber, such as confluence chamber 26; an inlet, such as inlet conduit 10, connected to the first chamber; an outlet, such as outlet conduit 20, connected to the second chamber; a bypass conduit, such as bypass conduit 14, passing from the inlet, through the first chamber, and into the second chamber; and a passage, such as opening and/or conduit 24, between the first and second chambers and configured to allow the liquid to flow from the first chamber to the second chamber, the passage located below the bypass conduit, wherein the bypass conduit comprises a first orifice, such as butterfly orifice 13, located within the first chamber and a second orifice, such as check dam regulator 17, located in the second chamber.

In one aspect, the second orifice comprises a notch in the bypass conduit, the notch having a height h relative to a bottom surface of the bypass conduit and a width w relative to an end of the bypass conduit. In one aspect, the bypass conduit is angled relative to a horizontal so that a lowest region of the second orifice is higher, in relation to the horizontal, than a highest region, such as a top cut 12, of the first orifice, such that liquid flow into the inlet, less than a design flow, flows substantially entirely through the first orifice. In one aspect, the bypass conduit is angled relative to the horizontal such that a substantial portion of liquid flow into the inlet, above the design flow, flows through the second orifice into the second chamber. In one aspect, the first orifice comprises a slot in the bypass conduit having an area A sufficient to allow a design flow of the liquid to substantially entirely flow through the first orifice. In one aspect, the first orifice defines a scoop in the bypass conduit shaped and configured to direct liquid flow from the inlet against a wall, such as wall 21, of the first chamber. In one aspect, the bypass conduit comprises a third orifice, such as transition purge orifice 15, located within the first chamber at a height approximately corresponding to a height of the second orifice.

In one aspect, a method of separating a liquid from other substances includes adjusting the angle of the bypass conduit to adjust the design flow, such as raising or lowering an end of the bypass conduit 14. In one aspect, the method comprises adjusting at least one of the height h and the width w of the notch to adjust the design flow. In one aspect, the method comprises adjusting the area A of the slot to adjust the design flow. In one aspect, the method comprises adjusting and/or balancing the angle of the bypass conduit and the height and the width of the notch to adjust the design flow.

It should be understood, of course, that the foregoing relates to exemplary embodiments of the invention and that modifications may be made without departing from the spirit and scope of the invention.

What is claimed is:

1. An apparatus for separating a liquid from other substances, comprising:
a first chamber;
a second chamber;
an inlet connected to the first chamber;
an outlet connected to the second chamber;
a bypass conduit passing from the inlet, through the first chamber, and into the second chamber; and
a passage between the first and second chambers and configured to allow the liquid to flow from the first chamber to the second chamber, the passage located below the bypass conduit,
wherein the bypass conduit comprises a first orifice located within the first chamber and a second orifice located in the second chamber.

2. The apparatus as claimed in claim 1, wherein the second orifice comprises a notch in the bypass conduit, the notch having a height relative to a bottom surface of the bypass conduit and a width relative to an end of the bypass conduit.

3. The apparatus as claimed in claim 1, wherein the bypass conduit is angled relative to a horizontal so that a lowest region of the second orifice is higher, in relation to the horizontal, than a highest region of the first orifice, such that liquid flow into the inlet, less than a design flow, flows substantially entirely through the first orifice.

4. The apparatus as claimed in claim 3, wherein the bypass conduit is angled relative to the horizontal such that a substantial portion of liquid flow into the inlet, above the design flow, flows through the second orifice into the second chamber.

5. The apparatus as claimed in claim 1, wherein the first orifice comprises a slot in the bypass conduit having an area sufficient to allow a design flow of the liquid to substantially entirely flow through the first orifice.

6. The apparatus as claimed in claim 5, wherein the first orifice defines a scoop in the bypass conduit shaped and configured to direct liquid flow from the inlet into the first chamber.

7. The apparatus as claimed in claim 1, wherein the bypass conduit comprises a third orifice located within the first chamber at a height approximately corresponding to a height of the second orifice.

8. The apparatus as claimed in claim 1, wherein the inlet, the bypass conduit, and the first and second orifices are integrally formed.

9. An apparatus for separating a liquid from other substances, comprising:
a first chamber;
a second chamber;
an inlet connected to the first chamber;
an outlet connected to the second chamber;
a bypass conduit passing from the inlet, through the first chamber, and into the second chamber;
a passage between the first and second chambers and configured to allow the liquid to flow from the first chamber to the second chamber, the passage located below the bypass conduit,
wherein the bypass conduit comprises a first orifice located within the first chamber and a second orifice located in the second chamber,
wherein the second orifice comprises a notch in the bypass conduit, the notch having a height relative to a bottom surface of the bypass conduit and a width relative to an end of the bypass conduit,
wherein the bypass conduit is angled at an angle relative to a horizontal so that a lowest region of the notch is higher, in relation to the horizontal, than a highest region of the first orifice, such that liquid flow into the inlet, less than a design flow, flows substantially entirely through the first orifice, and
wherein the first orifice comprises a slot in the bypass conduit having an area sufficient to allow liquid flow into the inlet, less than the design flow, to substantially entirely flow through the first orifice.

10. A method of separating a liquid from other substances, comprising:
providing the apparatus as claimed in claim 9;
providing a mixture of the liquid and other substances into the inlet; and
directing the liquid from the outlet.

11. The method as claimed in claim 10, further comprising adjusting the angle of the bypass conduit to adjust the design flow.

12. The method as claimed in claim 10, further comprising adjusting at least one of the height and the width of the notch to adjust the design flow.

13. The method as claimed in claim 10, further comprising adjusting the angle of the bypass conduit and the height and the width of the notch to adjust the design flow.
